(19) United States
(12) Patent Application Publication
(10) Pub. No.: US 2025/0136795 A1
(43) Pub. Date: May 1, 2025

(54) TIRE RUBBER COMPOSITION, AND TIRE

(71) Applicant: The Yokohama Rubber Co., LTD., Kanagawa (JP)

(72) Inventor: Kensuke HIJIKATA, Kanagawa (JP)

(21) Appl. No.: 18/694,245

(22) PCT Filed: Jun. 30, 2022
(86) PCT No.: PCT/JP2022/026181

§ 371 Date: Mar. 21, 2024

(30) Foreign Application Priority Data
Sep. 27, 2021 (JP) 2021-156326
Sep. 27, 2021 (JP) 2021-156331

(51) Int. Cl. C08L 9/06; B60C 1/00; C08K 3/22

(52) U.S. Cl. CPC C08L 9/06; B60C 1/0016; C08K 3/22; C08K 2003/2227

(57) ABSTRACT

The present technology discloses in one of the embodiments a rubber composition for tires including, per 100 parts by mass of a diene-based rubber containing a SBR having a styrene content of 30 mass % or more, from 140 to 300 parts by mass of a silica having a N₂SA of from 100 to 300 m²/g and a value of a nitrogen-adsorption specific surface area N₂SA/CTAB specific surface area of 1.10 or less, 15 parts by mass or more of aluminum hydroxide, 5 parts by mass or more of a liquid styrene-butadiene copolymer rubber having a vinyl content of 50 mass % or more and being unmodified, and 15 parts by mass or more of a tackifier resin having a softening point of from 60 to 180° C.

### TECHNICAL FIELD

The present technology relates to a rubber composition for tires and a tire using the same.

### BACKGROUND ART

Generally, tires for traveling on dry road surfaces and tires for traveling on wet road surfaces are prepared as pneumatic racing tires, and optimal tires for each of these tires are selected according to the weather and road surface state during travel. Here, in racing tires for traveling on wet road surfaces, a large amount of silica or aluminum hydroxide is blended in order to enhance wet grip performance (see, for example, Japan Patent No. 5827541 B). However, when a large amount of the above-mentioned inorganic filler is blended, there is an issue that wear resistance is deteriorated. While blending a large amount of resin allows for the wet grip performance to improve, the loss of grip caused by heat during long hours of driving is worsened by blending a large amount of resin.

Furthermore, in the technique disclosed in the above-mentioned Japan Patent No. 5827541 B, the viscosity of the compound increases, and the green strength decreases, which cause issues of deterioration in processability such as adhesion to the inside of the mixer. Also, when a large amount of oil is blended in order to lower the viscosity, there is an issue that the steering stability is lowered.

### SUMMARY

The present technology provides a rubber composition for tires that is excellent in wet grip performance and wear resistance and also excellent in loss of grip performance caused by heat, and a tire using the same.

Furthermore, the present technology provides a rubber composition for tires which is excellent in wet grip performance and processability and also excellent in steering stability, and a tire using the same.

The present technology provides, as Configuration (1), a rubber composition for tires including,
per 100 parts by mass of a diene-based rubber containing a styrene-butadiene copolymer rubber having a styrene content of 30 mass % or more,
from 140 to 300 parts by mass of a silica having a nitrogen-adsorption specific surface area N₂SA of from 100 to 300 m², and a value of a ratio of the nitrogen-adsorption specific surface area to a cetyltrimethylammonium bromide (CTAB) specific surface area (N₂SA/CTAB) of 1.10 or less,
15 parts by mass or more of aluminum hydroxide,
5 parts by mass or more of a liquid styrene-butadiene copolymer rubber having a vinyl content of 50 mass % or more and being unmodified, and
15 parts by mass or more of a tackifier resin having a softening point of from 60 to 180° C.

Furthermore, the present technology provides, as Configuration (2), a rubber composition for tires including: per 100 parts by mass of a diene-based rubber containing a styrene-butadiene copolymer rubber having a styrene content of 30 mass % or more, from 140 to 300 parts by mass of a silica having a nitrogen-adsorption specific surface area N₂SA of from 100 to 300 m²/g; and 15 parts by mass or more of a surface-treated aluminum hydroxide.

The rubber composition for tires of the above-mentioned Configuration (1) is characterized by including.
per 100 parts by mass of a diene-based rubber containing a styrene-butadiene copolymer rubber having a styrene content of 30 mass % or more,
from 140 to 300 parts by mass of a silica having a nitrogen-adsorption specific surface area N₂SA of from 100 to 300 m²/g, and a value of a nitrogen-adsorption specific surface area N₂SA/CTAB specific surface area of 1.10 or less,
15 parts by mass or more of aluminum hydroxide,
5 parts by mass or more of a liquid styrene-butadiene copolymer rubber having a vinyl content of 50 mass % or more and being unmodified, and
15 parts by mass or more of a tackifier resin having a softening point of from 60 to 180° C., and therefore, a rubber composition for tires which is excellent in wet grip performance and wear resistance, and also excellent in loss of grip performance caused by heat, as well as a tire using the same, can be provided.

The rubber composition for tires of the above-mentioned Configuration (2) is characterized by including,
per 100 parts by mass of a diene-based rubber containing a styrene-butadiene copolymer rubber having a styrene content of 30 mass % or more,
from 140 to 300 parts by mass of a silica having a nitrogen-adsorption specific surface area N₂SA of from 100 to 300 m²/g, and
15 parts by mass or more of a surface-treated aluminum hydroxide, and therefore, a rubber composition for tires which is excellent in wet grip performance and processability, and also excellent in steering stability, as well as a tire using the same, can be provided.

### DETAILED DESCRIPTION

The present technology will be described in further detail below. First, the rubber composition for tires of the above-mentioned Configuration (1) will be described,

### Diene Rubber

The diene-based rubber used in the above-mentioned Configuration (1) contains a styrene-butadiene copolymer rubber (SBR) as an essential component. When the entire amount of the diene-based rubber used in the present technology is taken as 100 parts by mass, the blended amount of SBR may be determined by appropriately taking into account various conditions such as air temperature and weather, when for example, it is for racing use. The blended amount can be, for example, 70 parts by mass or more, preferably 85 parts by mass or more, and further preferably 100 parts by mass. In the present technology, besides the SBR, any diene-based rubber that can be blended in ordinary rubber compositions may be used, and examples thereof include natural rubber (NR), isoprene rubber (IR), butadiene rubber (BR), acrylonitrile-butadiene copolymer rubber (NBR), and ethylenc-propylene-diene terpolymer (EPDM). These may be used alone, or two or more may be used in combination. Furthermore, the molecular weight and the microstructure thereof is not particularly limited. The diene rubber may be terminal-modified with an amine, amide, silyl, alkoxysilyl, carboxyl, or hydroxyl group or may be epoxidized.

The SBR used in the above-mentioned Configuration (1) preferably has a styrene content of 30 mass % or more. By satisfying such a styrene content, the wet grip performance, wear resistance and loss of grip performance caused by heat of tires can be enhanced. The styrene content is further preferably from 33 to 50 mass %.

Furthermore, the SBR used in the rubber composition of the above-mentioned Configuration (1) preferably has a weight average molecular weight of 10×10⁵ g/mol or more. By satisfying this weight average molecular weight, the wear resistance improves. A more preferable weight average molecular weight of the SBR is 10×10⁵ g/mol or more and 20×10⁵ g/moil or less.

Furthermore, the SBR used in the rubber composition of the above-mentioned Configuration (1) preferably has such a mass ratio that styrene content vinyl content, By satisfying this condition, the SBR has an effect that the hardness increases while ensuring Tg, and the wear resistance is improved.

### Silica

The silica used in the rubber composition of the above-mentioned Configuration (1) has a nitrogen-adsorption specific surface area N₂SA of from 100 to 300 m²/g, and a value of a nitrogen-adsorption specific surface area N₂SA/CTAB specific surface area of 1.10 or less (hereinafter sometimes referred to as Specific Silica 1).

When the N₂SA of Specific Silica 1 is less than 100 m²/g, the hardness and the strength at break are lowered, and thus the steering stability and the wear resistance are deteriorated.

Alternatively, when the N₂SA of Specific Silica 1 exceeds 300 m²/g, the viscosity will become too high, leading to difficulty in processing.

A more preferable N₂SA of Specific Silica 1 used in the rubber composition having the above-mentioned Configuration (1) is from 130 to 270 m²/l.

Note that the N₂SA is measured in accordance with JIS (Japanese Industrial Standard) K6217-2.

Furthermore, Specific Silica 1 used in the rubber composition of the above-mentioned Configuration (1) has a value of the nitrogen-adsorption specific surface area N₂SA/CTAB specific surface area of 1.10 or less. The value of the above-mentioned nitrogen-adsorption specific surface area N₂SA/CTAB specific surface area represents the state of the surface pores of silica. When the value of the nitrogen-adsorption specific surface area N₂SA/CTAB specific surface area is 1.10 or less, it is in a state where the number of surface pores of silica is small. Therefore, the SBR hardly enters the surface pores, enhancing the dispersibility of the silica and the interaction with the SBR, and thus the effect of the present technology is improved.

The value of the nitrogen-adsorption specific surface area N₂SA/CTAB specific surface area is preferably 1.08 to 0.90.

Note that the CTAB specific surface area of silica is measured in accordance with ISO (International Organization for Standardization) 5794/1.

### Aluminum Hydroxide

The aluminum hydroxide used in the rubber composition of the above-mentioned Configuration (1) is not particularly limited in terms of conditions such as its particle size distribution, and can be appropriately selected from known ones. Examples of commercially available products include BF013, available from Nippon Light Metal Co., Ltd., etc.

Furthermore, from the viewpoint of improving the effects of the present technology, the BET (Brunauer-Emmett-Teller) specific surface area of the aluminum hydroxide is preferably 10 m²/g or less, further preferably from 1 to 8 m²/g. Note that the BET specific surface area is measured in accordance with ISO 5794/1.

### Liquid Styrene-Butadiene Copolymer

In order to further improve the effect of the rubber composition of the above-mentioned Configuration (1), a liquid styrene-butadiene copolymer (liquid SBR) can be blended.

It is preferable that the liquid SBR has a vinyl content of 50 mass % or more (preferably from 50 to 90 mass %) and is unmodified. Furthermore, the liquid SBR having a weight average molecular weight of from 2000 to 40000 and preferably from 3000 to 20000 can be used. The “weight average molecular weight” in the present technology refers to a weight average molecular weight determined by gel permeation chromatography (GPC) based on calibration with polystyrene. By adopting such a liquid SBR, the interaction of the diene-based rubber with the SBR is enhanced, and the effects of the present technology, particularly the wear resistance, are improved. Note that the liquid SBR used in the present technology is a liquid at 23° C. Therefore, it is distinguished from the diene rubber that is solid at this temperature.

### Tackifier Resin

In the rubber composition of the above-mentioned Configuration (1), a tackifier resin can be blended in order to further improve its effect.

The tackifier resin used in the present technology is not particularly limited, and specific examples thereof include phenol-based resins (e.g., phenol resins, phenol-acetylene resins, and phenol-formaldehyde resins); coumarone-based resins (e.g., coumarone resins, coumarone-indene resins, and coumarone-indene-styrene resins): terpene-based resins (e.g., terpene resins, modified terpene resins (aromatic modified terpene resins, etc.), terpene phenol resins); styrene resins; acrylic resins; rosin-based resins (e.g., rosin, rosin esters, hydrogenated rosin derivatives); hydrogenated terpene resins; petroleum resins (e.g., C5 petroleum resins such as dicyclopentazine resins, C9 petroleum resins, alicyclic petroleum resins, and C5/C9 copolymerized petroleum resins); xylene-based resins (e.g., xylene resins, xylene-acetylene resins, and xylene-formaldehyde resins); α-pinene resins; and aliphatic saturated hydrocarbon resins. Among them, for the reason of superior effects and the like of the present technology, at least one selected from the group consisting of C9 petroleum resins, phenol resins, coumarone indene resins, terpene resins, styrene resins, acrylic resins, rosin resins, and dicyclopentadiene resins are preferable, and aromatic-based petroleum resins containing 30 mass % or more of indene are more preferable from the viewpoint of increasing tan δ (0° C.) and improving wet grip performance.

The softening point of the tackifier resin is preferably from 60 to 180° C. for the reason of achieving superior effects of the present technology.

Note that the above-mentioned softening point is measured in accordance with JIS K6220-1.

### Compounding Proportion of Rubber Composition

The rubber composition of the above-mentioned Configuration (1) includes, per 100 parts by mass of a diene-based rubber, from 140 to 300 parts by mass of Specific Silica 1, 15 parts by mass or more of aluminum hydroxide, 5 parts by mass or more of a liquid styrene-butadiene copolymer rubber (liquid SBR) having a vinyl content of 50 mass % or more and being unmodified, and 15 parts by mass or more of a tackifier resin having a softening point of from 60 to 180° C.

When the blended amount of Specific Silica 1 is less than 140 parts by mass, the hardness decreases and steering stability deteriorates. Conversely, when the blended amount of Specific Silica 1 exceeds 300 parts by mass, processability and steering stability deteriorate.

When the blended amount of aluminum hydroxide is less than 15 parts by mass, the wet grip performance cannot be improved.

When the blended amount of the liquid SBR is less than 5 parts by mass, the added amount is too small to exhibit the effect of the present technology.

When the blended amount of the tackifier resin is less than 15 parts by mass, the added amount is too small to exhibit the effect of the present technology.

In the above-mentioned Configuration (1), the blended amount of the Specific Silica 1 is preferably from 160 to 280 parts by mass, and more preferably from 170 to 260 parts by mass, per 100 parts by mass of the diene-based rubber.

The blended amount of the aluminum hydroxide is preferably from 10 to 80 parts by mass, and more preferably from 20 to 70 parts by mass, per 100 parts by mass of the diene-based rubber.

The blended amount of the liquid SBR is preferably from 5 to 50 parts by mass, and more preferably from 10 to 40 parts by mass, per 100 parts by mass of the diene-based rubber.

The blended amount of the tackifier resin is preferably from 25 to 70 parts by mass, and more preferably from 30 to 60 parts by mass, per 100 parts by mass of the diene-based rubber.

In the rubber composition having the above-mentioned Configuration (1), from 2 to 20 mass %, preferably from 5 to 16 mass % of a silane coupling agent is further blended with respect to the silica, and when the silane coupling agent is one represented by the following Compositional Formula (2), the wet grip performance, wear resistance, and loss of grip caused by heat can be further improved:

(A)ₐ(B)_{b}(C)_{c}(D)_{d}(R1)ₑSiO_{(4-2a-b-c-d-e)/2} (2)
where in Formula (2), A represents a divalent organic group having a sulfide group, B represents a monovalent hydrocarbon group having from 5 to 10 carbon atoms, C represents a hydrolyzable group, D represents an organic group having a mercapto group, R1 represents a monovalent hydrocarbon group having from 1 to 4 carbon atoms, and a to e satisfy the relationships: 0≤a<1, 0<b<1, 0<c<3, 0≤d<1, 0≤e<2, and 0<2a+b+c+d+e<4.

The silane coupling agent (polysiloxane) represented by Formula (2) and the production method thereof are known and disclosed, for example, in WO 2014/002750.

In Formula (2) above, A represents a divalent organic group having a sulfide group. Among these, a group represented by Formula (12) below is preferable:

*—(CH₂)ₙ—Sₓ—(CH₂)ₙ—* (12)

In Formula (12) above, n represents an integer of 1 to 10, among which an integer of 2 to 4 is preferable.

In Formula (12) above, x represents an integer of 1 to 6, among which an integer of 2 to 4 is preferable.

In Formula (12) above, * indicates a join position.

Specific examples of the group represented by Formula (12) above include *—CH₂—S₂—CH₂—*, *—C₂H₄—S₂—C₂H₄—*, *—C₃H₆—S₂—C₃H₆*, *—C₄H₈—S₂—C₄H₈—*, *—CH₂—S₄—CH₂—, *—C₂H₄—S₄—C₂H₄—*, —C₃H₆—S₄—C₃H₆—*, *—C₄H₈—S₄—C4H₈—*.

In Formula (2) above, B represents a monovalent hydrocarbon group having from 5 to 20 carbons, and specific examples thereof include a hexyl group, an octyl group, and a decyl group. B is preferably a monovalent hydrocarbon group having from 5 to 10 carbon atoms.

In Formula (2) above, C represents a hydrolyzable group, and specific examples thereof include alkoxy groups, a phenoxy group, a carboxyl group, and alkenyloxy groups. Among these, a group represented by Formula (13) below is preferable:

*—OR² (13)

In Formula (13) above, R² represents an alkyl group having from 1 to 20 carbon atoms, an aryl group having from 6 to 10 carbon atoms, an aralkyl group (aryl alkyl group) having from 6 to 10 carbon atoms, or an alkenyl group having from 2 to 10 carbon atoms, among which an alkyl group having from 1 to 5 carbon atoms is preferable. Specific examples of the alkyl group having from 1 to 20 carbons include a methyl group, an ethyl group, a propyl group, a butyl group, a hexyl group, an octyl group, a decyl group, and an octadecyl group. Specific examples of the aryl group having from 6 to 10 carbons include a phenyl group, and a tolyl group. Specific examples of the aralkyl group having from 6 to 10 carbons include a benzyl group, and a phenylethyl group. Specific examples of alkenyl groups having from 2 to 10 carbon atoms include a vinyl group, a propenyl group, and a pentenyl group.

In Formula (13) above, * indicates a join position.

In Formula (2) above, D is an organic group having a mercapto group. Among these, a group represented by Formula (14) below is preferable:

*—(CH₂)ₘ—SH (14)

In Formula (14) above, m represents an integer of 1 to 10, among which an integer of 1 to 5 is preferable.

In Formula (14) above, * indicates a join position.

Specific examples of the group represented by Formula (14) above include *—CH₂SH, *—C₂H₄SH, *—C₃H₆SH, *—C₄H₈SH, *—C₅H₁₀SH, *—C₆H₁₂SH, *—C₇H₁₄SH, —C₈H₁₆SH, *—C₉H₁₈SH, and *—C₁₀H₂₀SH.

In Formula (2) above, R1 represents a monovalent hydrocarbon group having from 1 to 4 carbon atoms.

In Formula (2) above, a to e satisfy the relationships 0≤a<1, 0<b<1, 0<c<3, 0<d<1, 0≤e 2, and 0<2a b+c d+e 4.

In Formula (2) above, a is preferably 0<a≤0.50 from the perspective of improving the effect of the present technology.

In Formula (2) above, b is preferably 0<b, and more preferably 0.10≤b≤0.89, from the perspective of improving the effect of the present technology.

In Formula (2) above, c is preferably 1.2≤c≤2.0 from the perspective of improving the effect of the present technology.

In Formula (2) above, d is preferably 0.1≤d≤0.8 from the perspective of improving the effect of the present technology.

The weight average molecular weight of the polysiloxane is preferably from 500 to 2300, and more preferably from 600 to 1500, from the perspective of improving the effect of the present technology. The molecular weight of the above-mentioned polysiloxane in the present technology is determined by gel permeation chromatography (GPC) based on calibration with polystyrene using toluene as a solvent.

The mercapto equivalent weight of the polysiloxane determined by the acetic acid/potassium iodide/potassium iodate addition-sodium thiosulfate solution titration method is preferably from 550 to 700 g/mol, and more preferably from 600 to 650 g/mol, from the perspective of having excellent vulcanization reactivity.

The polysiloxane is preferably a polysiloxane having from 2 to 50 siloxane units (—Si—O—) from the perspective of improving the effect of the present technology.

Note that other metals other than a silicon atom (e.g., Sn, Ti, and Al) are not present in the backbone of the polysiloxane.

The method of producing the polysiloxane is publicly known and, for example, the polysiloxane can be produced in accordance with the method disclosed in International Patent Publication No. WO 2014/002750.

### Other Components

The rubber composition in the above-mentioned Configuration (1) may contain, in addition to the components described above, vulcanizing or crosslinking agents; vulcanizing or crosslinking accelerators; various fillers, such as carbon black, clay, talc, and calcium carbonate; anti-aging agents; plasticizers; resins; curing agents; and other various additives commonly blended in rubber compositions. The additives are kneaded by a common method to obtain a composition that can then be used for vulcanization or crosslinking. Blended amounts of these additives may be any standard blended amount in the related art, so long as the object of the present technology is not hindered.

When a plasticizer is blended, the rubber composition in the above-mentioned Configuration (1) preferably contains 5 parts by mass or more, preferably from 15 to 60 parts by mass of a plasticizer containing a terpene resin, per 100 parts by mass of the diene-based rubber, from the viewpoint of improving the effect thereof. As the plasticizer containing a terpene resin commercially available products can be used, and examples thereof include PX300N, available from YASUHARA CHEMICAL CO., Ltd.

The rubber composition of the above-mentioned Configuration (1) is excellent in wet grip performance and wear resistance, and is also excellent in loss of grip performance caused by heat, and thus can be suitably used for a tread, particularly a cap tread, of a tire, preferably a tread, particularly a cap tread, of a racing tire. The tire according to an embodiment of the present technology is preferably a pneumatic tire that can be inflated with any gas including air and inert gas, such as nitrogen.

Next, the rubber composition for tires of the above-mentioned Configuration (2) will be described.

### Diene Rubber

The diene-based rubber used in the rubber composition of the above-mentioned Configuration (2) contains a styrene-butadiene copolymer rubber (SBR) as an essential component. When the entire amount of the diene-based rubber used in the present technology is taken as 100 parts by mass, the blended amount of SBR may be determined by appropriately taking into account various conditions such as air temperature and weather, for example, in a case of a racing application. The blended amount can be, for example, 70 parts by mass or more, preferably 85 parts by mass or more, and further preferably 100 parts by mass. In the present technology, besides the SBR, any diene-based rubber that can be blended in ordinary rubber compositions may be used in the first technology and examples thereof include natural rubber (NR), isoprene rubber (IR), butadiene rubber (BR), acrylonitrile-butadiene copolymer rubber (NBR), and ethylene-propylene-diene terpolymer (EPDM). These may be used alone, or two or more may be used in combination. Furthermore, the molecular weight and the microstructure thereof is not particularly limited. The diene rubber may be terminal-modified with an anine, amide, silyl, alkoxysilyl, carboxyl, or hydroxyl group or may be epoxidized.

Furthermore, the SBR used in the rubber composition of above-mentioned Configuration (2) preferably has a styrene content of 30 mass % or more. By satisfying such a styrene content, the wet grip performance and steering stability of the tire can be enhanced. The styrene content is further preferably from 33 to 50 mass %.

### Silica

The silica used in the rubber composition of the above-mentioned Configuration (2) has a nitrogen-adsorption specific surface area N₂SA of from 100 to 300 m²/g (hereinafter sometimes referred to as Specific Silica 2).

When the N₂SA of Specific Silica 2 is less than 100 m²/g, the hardness and the strength at break are lowered, and thus the steering stability and the wear resistance are deteriorated.

Alternatively, when the N₂SA of Specific Silica 2 exceeds 300 m²/g, the viscosity will become too high, leading to difficulty in processing.

A more preferable N₂SA of Specific Silica 2 used in the present technology is from 130 to 270 m²/g.

Note that the N₂SA is measured in accordance with JIS K6217-2.

### Surface-Treated Aluminum Hydroxide

The aluminum hydroxide used in the rubber composition of the above-mentioned Configuration (2) is an aluminum hydroxide that has been surface-treated with a surface treatment agent. Examples of such a surface treatment agent include a silane coupling agent, a higher fatty acid or a salt thereof, polymers, a titanate-based compound, an epoxy-based compound, an isocyanate-based compound, and a phosphoric acid ester. The surface treatment agent may be used in combination of two or more kinds. Among them, a silane coupling agent is preferable from the viewpoint of improving the effect of the present technology.

Examples of the silane coupling agent include vinyl group-containing silane-based coupling agents, (meth)acryloyl group-containing silane-based coupling agents, amino group-containing silane-based coupling agents, epoxy group-containing silane-based coupling agents, mercapto group-containing silane-based coupling agents, carboxyl group-containing silane-based coupling agents, and halogen atom-containing silane-based coupling agents.

The used amount of the surface treatment agent is, for example, from 0.1 to 10 parts by mass per 100 parts by mass of the aluminum hydroxide.

The method for surface treating the aluminum hydroxide may be appropriately selected from known methods such as a dry method, a wet method, and an integral blending method.

Furthermore, from the viewpoint of improving the effects of the present technology, the BET specific surface area of the aluminum hydroxide is preferably 10 m²/g or less, further preferably from 1 to 8 m²/g. Note that the BET specific surface area is measured in accordance with ISO 5794/1.

As the surface-treated aluminum hydroxide, commercially available aluminum hydroxide can be used, and examples thereof include Martinal series available from Huber.

### Compounding Proportion of Rubber Composition

The rubber composition of the above-mentioned Configuration (2) is obtained by blending from 140 to 300 parts by mass of Specific Silica 2 and 15 parts by mass or more of the surface-treated aluminum hydroxide, per 100 parts by mass of the diene-based rubber.

When the blended amount of Specific Silica 2 is less than 140 parts by mass, the hardness decreases and steering stability deteriorates. Conversely, when the blended amount of Specific Silica 2 exceeds 300 parts by mass, the processability and steering stability are lowered.

When the blended amount of the surface-treated aluminum hydroxide is less than 15 parts by mass, the wet grip performance cannot be improved.

Furthermore, in the rubber composition of the above-mentioned Configuration (2), the blended amount of the Specific Silica 2 is preferably from 160 to 280 parts by mass, further preferably from 170 to 260 parts by mass, per 100 parts by mass of the diene-based rubber.

The blended amount of the surface-treated aluminum hydroxide is preferably from 10 to 80 parts by mass, and more preferably from 20 to 70 parts by mass, per 100 parts by mass of the diene-based rubber.

Liquid Styrene-butadiene Copolymer

In order to further improve the effect of the rubber composition of the above-mentioned Configuration (2), a liquid styrene-butadiene copolymer (liquid SBR) can be blended.

It is preferable that the liquid SBR has a vinyl content of 50 mass % or more (preferably 50 to 90 mass %) and is unmodified. Furthermore, as the liquid SBR, those having a weight average molecular weight of from 2000 to 40000 and preferably from 3000 to 20000 can be used. The “weight average molecular weight” in the present technology refers to a weight average molecular weight determined by gel permeation chromatography (GPC) based on calibration with polystyrene. Note that the liquid SBR used in the present technology is a liquid at 23° C. Therefore, it is distinguished from the diene rubber that is solid at this temperature.

The blended amount of the liquid SBR is preferably from 5 parts by mass or more, and more preferably from 5 to 50 parts by mass, per 100 parts by mass of the diene-based rubber.

### Tackifier Resin

In the rubber composition of the above-mentioned Configuration (2), a tackifier resin can be blended in order to further improve the effect.

The tackifier resin used in the present technology is not particularly limited, and specific examples thereof include phenol-based resins (e.g., phenol resins, phenol-acetylene resins, and phenol-formaldehyde resins): coumarone-based resins (e.g., coumarone resins, coumarone-indene resins, and coumarone-indene-styrene resins); terpene-based resins (e.g., terpene resins, modified terpene resins (aromatic modified terpene resins, etc.), terpene phenol resins); styrene resins; acrylic resins; rosin-based resins (e.g., rosin, rosin esters, hydrogenated rosin derivatives); hydrogenated terpene resins; petroleum resins (e.g., C5 petroleum resins such as dicyclopentazine resins, C9 petroleum resins, alicyclic petroleum resins, and C5/C9 copolymerized petroleum resins); xylene-based resins (e.g., xylene resins, xylene-acetylene resins, and xylene-formaldehyde resins); α-pinene resins; and aliphatic saturated hydrocarbon resins. Among them, for the reason of superior effects, etc. of the present technology, at least one selected from the group consisting of C9 petroleum resins, phenol resins, a coumarone indene resins, a terpene resins, a styrene resin, an acrylic resins, rosin resin, and dicyclopentadiene resins are preferable.

The softening point of the tackifier resin is preferably from 60 to 180° C. from the perspective of achieving superior effects of the present technology.

Note that the above-mentioned softening point is measured in accordance with JIS K6220-1.

In the rubber composition of the above-mentioned Configuration (2), the blended amount of the tackifier resin is preferably 15 parts by mass or more, more preferably 25 to 70 parts by mass, and particularly preferably 30 to 60 parts by mass per 100 parts by mass of the diene-based rubber.

In the rubber composition having the above-mentioned Configuration (2), from 2 to 20 mass %, preferably from 5 to 16 mass % of a silane coupling agent is further blended with respect to the silica, and when the silane coupling agent is one represented by the compositional formula of above-mentioned (2), the wet grip performance, processability and steering stability can be further improved.

### Other Components

The rubber composition of the above-mentioned Configuration (2) may contain, in addition to the components described above, vulcanizing or crosslinking agents; vulcanizing or crosslinking accelerators: various fillers, such as zinc oxide, carbon black, clay, talc, and calcium carbonate; anti-aging agents: plasticizers; and other various additives commonly blended in rubber compositions. The additives are kneaded by a common method to obtain a composition that can then be used for vulcanization or crosslinking. Blended amounts of these additives may be any standard blended amount in the related art, so long as the object of the present technology is not hindered.

Since the rubber composition of the above-mentioned Configuration (2) is excellent in wet grip performance and processability and is also excellent in steering stability, it can be suitably used for a tread of a tire, particularly a cap tread, preferably a tread of a racing tire, particularly a cap tread. The tire according to an embodiment of the present technology is preferably a pneumatic tire that can be inflated with any gas including air and inert gas, such as nitrogen.

### EXAMPLE

The present technology will be described in further detail by way of examples and comparative examples, but the present technology is not limited by these examples. First, Examples and Comparative Examples of the rubber composition of the above-mentioned Configuration (1) will be described.

### Method for Producing Modified Liquid SBR

Methyltriethoxysilane as a modifier was reacted with a polymerization active end of a solution-polymerized styrene butadiene rubber synthesized by anionic polymerization of styrene and 1,3-butadiene using lithium dimethylamide as an initiator to obtain a modified liquid SBR modified at the end.

### Standard Example 1, Examples 1 to 6, and Comparative Examples 1 to 5 Preparation of Sample

According to the compounding proportion (parts by mass) presented in Table 1, the components other than the vulcanization components (vulcanization accelerator and sulfur), were kneaded for 5 minutes in a 1.7-L sealed Banbury Mixer. The obtained mixture was then discharged from the mixer and cooled to room temperature. Thereafter, the rubber composition was obtained by placing the composition in the same Banbury Mixer again, adding the vulcanization components, and kneading.

Next, a pneumatic tire having a tire size of 225/40R18 was produced using the rubber composition in a tread portion and vulcanization, and evaluated as presented below.

Wet grip performance: The obtained pneumatic tire was assembled to a wheel having a rim size of 17×8 J, and mounted on a test vehicle of a domestic 2 liter class, and actual vehicle travel was per on a test course of 1.2 kin per turn made of a wet road surface or a dry road surface (water depth below the top of unevenness of the road) under the condition of an air pressure of 240 kPa, and a lap time for each turn when the pneumatic tire continuously traveled 10 turns was measured, and the fastest lap time was obtained as a result. The results were expressed as index values with Standard Example 1 being assigned the value of 100. The larger the index, the faster the lap time, and the better the wet grip performance.

Resistance to loss of grip caused by heat: using the above-mentioned rubber composition, M300 (RT)/M300 (60° C.) was determined. Specifically, a tensile test was per at room temperature (RT) or 60° C. on the basis of JIS K6251 (using No. 3 dumbbell) to determine the 300% deformation modulus (M300). The results were expressed as index values with Standard Example 1 being assigned the value of 100. The larger the index, the lower the temperature dependency, and the better the loss of grip performance caused by heat.

Wear resistance: using the above-mentioned rubber composition, the breaking elongation was evaluated at room temperature by a tensile test in accordance with JIS K6251. The results are expressed as index values with Standard Example 1 being assigned the value of 100. Larger index values indicate better strength at break and better wear resistance.

The results are present in Table 1.

TABLE 1

| | Standard | Comparative | | |
|---|---|---|---|---|
| | Example 1 | Example 1 | Example 1 | Example 2 |
| SBR 1 *1 | 137.5 | 137.5 | 137.5 | 137.5 |
| SBR 2 *2 | — | — | — | — |
| SBR 3 *3 | — | — | — | — |
| SBR 4 *4 | — | — | — | — |
| Silica 1 *5 | 180.0 | 180.0 | — | — |
| Silica 2 *6 | — | — | 180.0 | 180.0 |
| Silica 3 *7 | — | — | — | — |
| Carbon black *8 | 10.0 | 10.0 | 10.0 | 10.0 |
| Aluminum hydroxide *9 | 30.0 | 30.0 | 30.0 | 30.0 |
| Tackifier resin 1 *10 | 30.0 | 30.0 | 30.0 | — |
| Tackifier resin 2 *11 | — | — | — | 30.0 |
| Silane coupling agent 1 *12 | 14.4 | 14.4 | 14.4 | 14.4 |
| Silane coupling agent 2 *13 | — | — | — | — |
| Liquid SBR 1 *14 | 15.0 | 15.0 | 15.0 | 15.0 |
| Liquid SBR 2 *15 | — | — | — | — |
| Liquid SBR 3 *16 | — | — | — | — |
| Plasticizer 1 *17 | 30.0 | 30.0 | 30.0 | 30.0 |
| Plasticizer 2 *18 | — | — | — | — |
| Stearic acid *19 | 2.0 | 2.0 | 2.0 | 2.0 |
| Zinc oxide *20 | 2.0 | 2.0 | 2.0 | 2.0 |
| Anti-aging agent *21 | 2.0 | 2.0 | 2.0 | 2.0 |
| Vulcanization accelerator 1 *22 | 1.5 | 1.5 | 1.5 | 1.5 |
| Vulcanization accelerator 2 *23 | 2.0 | 2.0 | 2.0 | 2.0 |
| Sulfur *24 | 1.5 | 1.5 | 1.5 | 1.5 |
| Measurement result | | | | |
| Wet grip performance (wet road surface) | 100 | 107 | 113 | 117 |
| Wet grip performance (half-dried road surface) | 100 | 108 | 114 | 114 |
| Resistance to loss of grip caused by heat | 100 | 100 | 101 | 105 |
| Wear resistance | 100 | 96 | 102 | 105 |

| | Example 3 | Example 4 | Example 5 | Example 6 |
|---|---|---|---|---|
| SBR 1 *1 | 137.5 | 137.5 | — | — |
| SBR 2 *2 | — | — | — | — |
| SBR 3 *3 | — | — | 137.5 | — |
| SBR 4 *4 | — | — | — | 137.5 |
| Silica 1 *5 | — | — | — | — |
| Silica 2 *6 | 180.0 | 180.0 | 180.0 | 180.0 |
| Silica 3 *7 | — | — | — | — |
| Carbon black *8 | 10.0 | 10.0 | 10.0 | 10.0 |
| Aluminum hydroxide *9 | 30.0 | 30.0 | 30.0 | 30.0 |
| Tackifier resin 1 *10 | — | — | — | — |
| Tackifier resin 2 *11 | 30.0 | 30.0 | 30.0 | 30.0 |
| Silane coupling agent 1 *12 | 14.4 | — | — | — |
| Silane coupling agent 2 *13 | — | 14.4 | 14.4 | 14.4 |
| Liquid SBR 1 *14 | 15.0 | 15.0 | 15.0 | 15.0 |
| Liquid SBR 2 *15 | — | — | — | — |
| Liquid SBR 3 *16 | — | — | — | — |
| Plasticizer 1 *17 | 20.0 | 30.0 | 30.0 | 30.0 |
| Plasticizer 2 *18 | 10.0 | — | — | — |
| Stearic acid *19 | 2.0 | 2.0 | 2.0 | 2.0 |
| Zinc oxide *20 | 2.0 | 2.0 | 2.0 | 2.0 |
| Anti-aging agent *21 | 2.0 | 2.0 | 2.0 | 2.0 |
| Vulcanization accelerator 1 *22 | 1.5 | 1.5 | 1.5 | 1.5 |
| Vulcanization accelerator 2 *23 | 2.0 | 2.0 | 2.0 | 2.0 |
| Sulfur *24 | 1.5 | 1.5 | 1.5 | 1.5 |
| Measurement result | | | | |
| Wet grip performance (wet road surface) | 118 | 121 | 121 | 120 |
| Wet grip performance (half-dried road surface) | 117 | 116 | 117 | 118 |
| Resistance to loss of grip caused by heat | 107 | 102 | 105 | 108 |
| Wear resistance | 106 | 101 | 106 | 111 |
| | Comparative | Comparative | Comparative | Comparative |
| | Example 2 | Example 3 | Example 4 | Example 5 |
| SBR 1 *1 | 137.5 | 137.5 | 137.5 | — |
| SBR 2 *2 | — | — | — | 137.5 |
| SBR 3 *3 | — | — | — | — |
| SBR 4 *4 | — | — | — | — |
| Silica 1 *5 | — | — | — | — |
| Silica 2 *6 | — | 180.0 | 180.0 | 180.0 |
| Silica 3 *7 | 180.0 | — | — | — |
| Carbon black *8 | 10.0 | 10.0 | 10.0 | 10.0 |
| Aluminum hydroxide *9 | 30.0 | 30.0 | 30.0 | 30.0 |
| Tackifier resin 1 *10 | 30.0 | 30.0 | 30.0 | 30.0 |
| Tackifier resin 2 *11 | — | — | — | — |
| Silane coupling agent 1 *12 | 14.4 | 14.4 | 14.4 | 14.4 |
| Silane coupling agent 2 *13 | — | — | — | — |
| Liquid SBR 1 *14 | 15.0 | — | — | 15.0 |
| Liquid SBR 2 *15 | — | 15.0 | — | — |
| Liquid SBR 3 *16 | — | — | 15.0 | — |
| Plasticizer 1 *17 | 30.0 | 30.0 | 30.0 | 30.0 |
| Plasticizer 2 *18 | — | — | — | — |
| Stearic acid *19 | 2.0 | 2.0 | 2.0 | 2.0 |
| Zinc oxide *20 | 2.0 | 2.0 | 2.0 | 2.0 |
| Anti-aging agent *21 | 2.0 | 2.0 | 2.0 | 2.0 |
| Vulcanization accelerator 1 *22 | 1.5 | 1.5 | 1.5 | 1.5 |
| Vulcanization accelerator 2 *23 | 2.0 | 2.0 | 2.0 | 2.0 |
| Sulfur *24 | 1.5 | 1.5 | 1.5 | 1.5 |
| Measurement result | | | | |
| Wet grip performance (wet road surface) | 105 | 98 | 97 | 108 |
| Wet grip performance (half-dried road surface) | 108 | 99 | 115 | 107 |
| Resistance to loss of grip caused by heat | 100 | 103 | 104 | 97 |
| Wear resistance | 95 | 101 | 104 | 98 |

*1: SBR 1 (Nipol NS522, available from ZS Elastomer Co., Ltd. (styrene content = 39 mass %, vinyl content = 42 mass %, weight-average molecular weight = 8.4 × 10⁵ g/mol, oil extender content = 37.5 parts by mass per 100 parts by mass of SBR))
*2: SBR 2 (Nipol NS460, available from ZS Elastomer Co., Ltd, (styrene content = 25 mass %, vinyl content = 63 mass %, weight-average molecular weight = 9.5 × 10⁵ g/mol, oil extender content = 37.5 parts by mass per 100 parts by mass of SBR))
*3: SBR 3 (HP776, available from JSR Corporation (styrene content = 32 mass %, vinyl content = 56 mass %, weight-average molecular weight = 12.1 × 10⁵ g/mol, oil extender content = 37.5 parts by mass per 100 parts by mass of SBR))
*4: SBR 4 (VSL2438-2, available from LANXESS (styrene content = 38 mass %, vinyl content = 24 mass %, weight-average molecular weight = 10.9 × 10⁵ g/mol, oil extender content = 37.5 parts by mass per 100 parts by mass of SBR))
*5: Silica 1 (VN3GR, available from Evonik Industries AG, nitrogen-adsorption specific surface area (N₂SA) = 181 m²/g, N₂SA/CTAB specific surface area = 1.12)
*6: Silica 2 (Ultrasil 7000 GR, available from Evonik Industries AG, nitrogen-adsorption specific surface area (N₂SA) = 171 m²/g, N₂SA/CTAB specific surface area = 1.03)
*7: Silica 3 (Zeosil 1085GR, available from Solvay Co. (nitrogen-adsorption specific surface area (N₂SA) = 86 m²/g, N₂SA/CTAB specific surface area = 0.99)
*8: Carbon black (SEAST 9, available from Tokai Carbon Co., Ltd. (nitrogen-adsorption specific surface area (N₂SA) = 142 m²/g, N₂SA/IA = 1.02))
*9: Aluminum hydroxide (BF013, available from Nippon Light Metal Co., Ltd.)
*10: Tackifier resin 1 (FTR2140, available from Mitsui Chemicals, Inc., aromatic-based hydrocarbon resin, softening point = 137° C., indene content = 0 mass %)
*11: Tackifier resin 2 (Neopolymer 140S, available from ENEOS Co., Ltd., C9 petroleum resin, softening point = 145° C., indene content = 48 mass %)
*12: Silane coupling agent 1 (Si69, available from Evonik Industries AG)
*13: Silane coupling agent 2 (a silane coupling agent which was prepared by the production method disclosed in WO 2014/002750 and satisfies the compositional formula of the above-mentioned (2). Compositional formula = (—C₃H₆—S₄—C₃H₆—)_{0.083}(—C₈H₁₇)_{0.667}(—OC₂H₅)_{1.50}(—C₃H₆SH)_{0.167}SiO_{0.75}; average molecular weight = 860)
*14: Liquid SBR 1 (Ricon 100, available from Cray Valley, vinyl content = 70 mass %, unmodified)
*15: Liquid SBR 2 (Ricon 184, available from Cray Valley, vinyl content = 30 mass %, unmodified)
*16: Liquid SBR 3 (modified liquid SBR based on the above-mentioned production method, vinyl content = 70 mass %, silane-modified)
*17: Plasticizer 1 (Extract No. 4S, available from Shell Lubricants Japan K.K.)
*18: Plasticizer 2 (PX300N, available from YASUHARA CHEMICAL CO., LTD., made of a terpene resin)
*19: Stearic acid (Beads Stearic Acid YR, available from NOF Corporation)
*20: Zinc oxide (Zinc Oxides III, available from Seido Chemical Industry Co., Ltd.)
*21: Anti-aging agent (6PPD, available from Flexsys)
*22: Vulcanization accelerator 1 (SANCELER D-G, available from Sanshin Chemical Industry Co., Ltd.)
*23: Vulcanization accelerator 2 (NOCCELER CZ-G, available from Ouchi Shinko Chemical Industrial Co., Ltd.)
*24: Sulfur (Golden Flower oil treated sulfur powder, available from Tsurumi Chemical Industry Co., Ltd.)

Based on the results of Table 1, the rubber composition of each Example included, per 100 parts by mass of a diene-based rubber containing a styrene-butadiene copolymer rubber having a styrene content of 30 mass % or more, from 140 to 300 parts by mass of a silica having a nitrogen-adsorption specific surface area N₂SA of from 100 to 300 m/g and a value of a nitrogen-adsorption specific surface area N₂SA/CTAB specific surface area of 1.10 or less, 15 parts by mass or more of aluminum hydroxide, 5 parts by mass or more of a liquid styrene-butadiene copolymer rubber having a vinyl content of 50 mass % or more and being unmodified, and 15 parts by mass or more of a tackifier resin having a softening point of from 60 to 180° C. Therefore, the rubber composition was excellent in wet grip performance and wear resistance, and also excellent in loss of grip performance caused by heat.

Meanwhile, in Comparative Example 1, since the value of the N₂SA/CTAB specific surface area of silica exceeds 1.10, the wear resistance is deteriorated.

In Comparative Example 2, since the N₂SA of the silica was less than the lower limit defined in the above-mentioned Configuration (1), the wear resistance was lowered.

In Comparative Example 3, since the vinyl content of the liquid SBR was less than the lower limit defined in the above-mentioned Configuration (1), the wet grip performance was lowered.

In Comparative Example 4, since the liquid SBR had been modified with maleic acid, the wet grip performance was lowered.

In Comparative Example 5, since the styrene content in the SBR was less than the lower limit defined by the above-mentioned Configuration (1), resistance to loss of grip caused by heat and the wear resistance were deteriorated.

Next, Examples and Comparative Examples of the rubber composition having the above-mentioned Configuration (2) will be described.

### Method for Producing Modified Liquid SBR

Methyltriethoxysilane as a modifier was reacted with a polymerization active end of a solution-polymerized styrene butadiene rubber synthesized by anionic polymerization of styrene and 1,3-butadiene using lithium dimethylamide as an initiator to obtain a modified liquid SBR modified at the end.

### Standard Example 2, Examples 7 to 14 and Comparative Examples 6 to 10 Preparation of Sample

According to the compounding proportion (parts by mass) presented in Table 2, the components other than the vulcanization components (vulcanization accelerator and sulfur), were kneaded for 5 minutes in a 1.7-L sealed Banbury Mixer. The obtained mixture was then discharged from the mixer and cooled to room temperature. Thereafter, the rubber composition was obtained by placing the composition in the same Banbury Mixer again, adding the vulcanization components, and kneading.

Next, a pneumatic tire having a tire size of 225/40R18 was produced using the rubber composition in a tread portion and vulcanization, and evaluated as presented below.

Wet grip performance: The obtained pneumatic tire was assembled to a wheel having a rim size of 17×8 J and mounted on a test vehicle of a domestic 2 liter class, and actual vehicle travel was per on a test course of 1.2 kin per turn made of a wet road surface or a dry road surface (water depth below the top of unevenness of the road) under the condition of an air pressure of 240 kPa, and a lap time for each turn when the pneumatic tire continuously traveled 10 turns was measured, and the fastest lap time was obtained as a result. The results are expressed as index values with the Standard Example 2 being assigned the value of 100. The larger the index, the faster the lap time, and the better the wet grip performance.

Processability 1 (Mooney viscosity): using the above-mentioned rubber composition, the Mooney viscosity of an unvulcanized rubber at 100° C. was measured in accordance with JIS K6300. The results are expressed as index values with Standard Example 2 being assigned the value of 100. A larger index indicates a lower viscosity and thus indicates superior processability.

Processability 2 (green strength): using the above-mentioned rubber composition (unvulcanized), according to JIS K6251:2010, a JIS No. 3 dumbbell-shaped test piece (thickness: 2 mm) was punched out, and the 300% modulus was measured under the conditions of a temperature of 20° C. and a tensile speed of 500 mm/min. The results are expressed as index values with the Standard Example 2 being assigned the value of 100. The larger the index, the better the green strength and the better the processability.

Steering stability: In accordance with JIS K6253, a type A durometer was used to measure rubber hardness of the obtained samples at a temperature of 60° C. The results are expressed as index values with the Standard Example 2 being assigned the value of 100. Larger index values indicate higher hardness and superior steering stability.

The results are presented in Table 2.

TABLE 2

| | Standard | Comparative | Comparative |
|---|---|---|---|
| | Example 2 | Example 6 | Example 7 |
| SBR 1 *25 | 137.5 | 137.5 | 137.5 |
| SBR 2 *26 | — | — | — |
| Silica 1 *27 | 180.0 | 180.0 | 180.0 |
| Silica 2 *28 | — | — | — |
| Carbon black *29 | 10.0 | 10.0 | 10.0 |
| Aluminum hydroxide 1 *30 | — | 30.0 | 30.0 |
| Aluminum hydroxide 2 *31 | — | — | — |
| Aluminum hydroxide 3 *32 | — | — | — |
| Aluminum hydroxide 4 *33 | — | — | — |
| Aluminum hydroxide 5 *34 | — | — | — |
| Tackifier resin 1 *35 | 30.0 | 30.0 | 30.0 |
| Tackifier resin 2 *36 | — | — | — |
| Silane coupling agent 1 *37 | 14.4 | 14.4 | 14.4 |
| Silane coupling agent 2 *38 | — | — | — |
| Liquid SBR 1 *39 | 15.0 | 15.0 | 15.0 |
| Liquid SBR 2 *40 | — | — | — |
| Liquid SBR 3 *41 | — | — | — |
| Plasticizer *42 | 30.0 | 30.0 | 30.0 |
| Stearic acid *43 | 2.0 | 2.0 | 2.0 |
| Zinc oxide *44 | 2.0 | 2.0 | 2.0 |
| Anti-aging agent *45 | 2.0 | 2.0 | 2.0 |
| Vulcanization accelerator 1 *46 | 1.5 | 1.5 | 1.5 |
| Vulcanization accelerator 2 *47 | 2.0 | 2.0 | 2.0 |
| Sulfur *48 | 1.5 | 1.5 | 1.5 |
| Measurement result | | | |
| Wet grip performance (wet road surface) | 100 | 107 | 108 |
| Wet grip performance (half-dried road surface) | 100 | 108 | 107 |
| Processability 1 (1/MV) | 100 | 100 | 99 |
| Processability 2 (green strength) | 100 | 97 | 94 |
| Steering stability | 100 | 101 | 102 |

| | Example 7 | Example 8 | Example 9 | Example 10 |
|---|---|---|---|---|
| SBR 1 *25 | 137.5 | 137.5 | 137.5 | 137.5 |
| SBR 2 *26 | — | — | — | — |
| Silica 1 *27 | 180.0 | 180.0 | 180.0 | 180.0 |
| Silica 2 *28 | — | — | — | — |
| Carbon black *29 | 10.0 | 10.0 | 10.0 | 10.0 |
| Aluminum hydroxide 1 *30 | — | — | — | — |
| Aluminum hydroxide 2 *31 | 30.0 | — | — | — |
| Aluminum hydroxide 3 *32 | — | 30.0 | — | — |
| Aluminum hydroxide 4 *33 | — | — | 30.0 | — |
| Aluminum hydroxide 5 *34 | — | — | — | 30.0 |
| Tackifier resin 1 *35 | 30.0 | 30.0 | 30.0 | 30.0 |
| Tackifier resin 2 *36 | — | — | — | — |
| Silane coupling agent 1 *37 | 14.4 | 14.4 | 14.4 | 14.4 |
| Silane coupling agent 2 *38 | — | — | — | — |
| Liquid SBR 1 *39 | 15.0 | 15.0 | 15.0 | 15.0 |
| Liquid SBR 2 *40 | — | — | — | — |
| Liquid SBR 3 *41 | — | — | — | — |
| Plasticizer *42 | 30.0 | 30.0 | 30.0 | 30.0 |
| Stearic acid *43 | 2.0 | 2.0 | 2.0 | 2.0 |
| Zinc oxide *44 | 2.0 | 2.0 | 2.0 | 2.0 |
| Anti-aging agent *45 | 2.0 | 2.0 | 2.0 | 2.0 |
| Vulcanization accelerator 1 *46 | 1.5 | 1.5 | 1.5 | 1.5 |
| Vulcanization accelerator 2 *47 | 2.0 | 2.0 | 2.0 | 2.0 |
| Sulfur *48 | 1.5 | 1.5 | 1.5 | 1.5 |
| Measurement result | | | | |
| Wet grip performance (wet road surface) | 108 | 110 | 113 | 110 |
| Wet grip performance (half-dried road surface) | 111 | 112 | 115 | 117 |
| Processability 1 (1/MV) | 102 | 102 | 102 | 101 |
| Processability 2 (green strength) | 100 | 101 | 102 | 101 |
| Steering stability | 102 | 101 | 104 | 105 |

| | Example 11 | Example 12 | Example 13 | Example 14 |
|---|---|---|---|---|
| SBR 1 *25 | 137.5 | 137.5 | 137.5 | 137.5 |
| SBR 2 *26 | — | — | — | — |
| Silica 1 *27 | 180.0 | 180.0 | 180.0 | 180.0 |
| Silica 2 *28 | — | — | — | — |
| Carbon black *29 | 10.0 | 10.0 | 10.0 | 10.0 |
| Aluminum hydroxide 1 *30 | — | — | — | — |
| Aluminum hydroxide 2 *31 | — | — | — | — |
| Aluminum hydroxide 3 *32 | — | — | — | — |
| Aluminum hydroxide 4 *33 | — | — | — | — |
| Aluminum hydroxide 5 *34 | 30.0 | 30.0 | 30.0 | 30.0 |
| Tackifier resin 1 *35 | — | 30.0 | 30.0 | 30.0 |
| Tackifier resin 2 *36 | 30.0 | — | — | — |
| Silane coupling agent 1 *37 | 14.4 | — | 14.4 | 14.4 |
| Silane coupling agent 2 *38 | — | 14.4 | — | — |
| Liquid SBR 1 *39 | 15.0 | 15.0 | — | — |
| Liquid SBR 2 *40 | — | — | 15.0 | — |
| Liquid SBR 3 *41 | — | — | — | 15.0 |
| Plasticizer *42 | 30.0 | 30.0 | 30.0 | 30.0 |
| Stearic acid *43 | 2.0 | 2.0 | 2.0 | 2.0 |
| Zinc oxide *44 | 2.0 | 2.0 | 2.0 | 2.0 |
| Anti-aging agent *45 | 2.0 | 2.0 | 2.0 | 2.0 |
| Vulcanization accelerator 1 *46 | 1.5 | 1.5 | 1.5 | 1.5 |
| Vulcanization accelerator 2 *47 | 2.0 | 2.0 | 2.0 | 2.0 |
| Sulfur *48 | 1.5 | 1.5 | 1.5 | 1.5 |
| Measurement result | | | | |
| Wet grip performance (wet road surface) | 112 | 121 | 106 | 100 |
| Wet grip performance (half-dried road surface) | 114 | 116 | 103 | 103 |
| Processability 1 (1/MV) | 100 | 109 | 103 | 100 |
| Processability 2 (green strength) | 100 | 105 | 102 | 100 |
| Steering stability | 103 | 101 | 100 | 105 |

| | Comparative | Comparative | Comparative |
|---|---|---|---|
| | Example 8 | Example 9 | Example 10 |
| SBR 1 *25 | 137.5 | — | — |
| SBR 2 *26 | — | 137.5 | 137.5 |
| Silica 1 *27 | — | 180.0 | 180.0 |
| Silica 2 *28 | 180.0 | — | — |
| Carbon black *29 | 10.0 | 10.0 | 10.0 |
| Aluminum hydroxide 1 *30 | — | 30.0 | — |
| Aluminum hydroxide 2 *31 | — | — | — |
| Aluminum hydroxide 3 *32 | — | — | — |
| Aluminum hydroxide 4 *33 | — | — | — |
| Aluminum hydroxide 5 *34 | 30.0 | — | 30.0 |
| Tackifier resin 1 *35 | 30.0 | 30.0 | 30.0 |
| Tackifier resin 2 *36 | — | — | — |
| Silane coupling agent 1 *37 | 14.4 | 14.4 | 14.4 |
| Silane coupling agent 2 *38 | — | — | — |
| Liquid SBR 1 *39 | 15.0 | 15.0 | 15.0 |
| Liquid SBR 2 *40 | — | — | — |
| Liquid SBR 3 *41 | — | — | — |
| Plasticizer *42 | 30.0 | 30.0 | 30.0 |
| Stearic acid *43 | 2.0 | 2.0 | 2.0 |
| Zinc oxide *44 | 2.0 | 2.0 | 2.0 |
| Anti-aging agent *45 | 2.0 | 2.0 | 2.0 |
| Vulcanization accelerator 1 *46 | 1.5 | 1.5 | 1.5 |
| Vulcanization accelerator 2 *47 | 2.0 | 2.0 | 2.0 |
| Sulfur *48 | 1.5 | 1.5 | 1.5 |
| Measurement result | | | |
| Wet grip performance (wet road surface) | 103 | 108 | 110 |
| Wet grip performance (half-dried road surface) | 105 | 107 | 115 |
| Processability 1 (1/MV) | 111 | 97 | 98 |
| Processability 2 (green strength) | 98 | 95 | 98 |
| Steering stability | 98 | 98 | 103 |

*25: SBR 1 (Nipol NS522, available from ZS Elastomer Co., Ltd. (styrene content = 39 mass %, oil extender content = 37.5 parts by mass per 100 parts by mass of SBR))
*26: SBR 2 (Nipol NS460, available from ZS Elastomer Co., Ltd. (styrene content = 25 mass %, oil extender content = 37.5 parts by mass per 100 parts by mass of SBR))
*27: Silica 1 (VN3GR, available from Evonik Industries AG (nitrogen-adsorption specific surface area (N₂SA) = 181 m²/g))
*28: Silica 2 (Zeosil 1085GR, available from Solvay (nitrogen-adsorption specific surface area (N₂SA) = 86 m²/g, N₂SA/CTAB = 0.99))
*29: Carbon black (SEAST 9, available from Tokai Carbon Co., Ltd. (nitrogen-adsorption specific surface area (N₂SA) = 142 m²/g, N₂SA/IA = 1.02))
*30: Aluminum hydroxide 1 (Martinal OL-104LEO, available from Huber (without surface treatment))
*31: Aluminum hydroxide 2 (Martinal OL-104C, available from Huber (surface treated with stearic acid))
*32: Aluminum hydroxide 3 (Martinal OL-104GO, available from Huber (surface-treated with a polymer))
*33: Aluminum hydroxide 4 (Martinal OL-104IO, available from Huber (surface treated with an aminosilane))
*34: Aluminum hydroxide 5 (Martinal OL-104ZO, available from Huber (surface treated with a vinylsilane))
*35: Tackifier resin 1 (Neopolymer 140S, available from ENEOS Co., Ltd., C9 petroleum resin, softening point = 145° C.)
*36: Tackifier resin 2 (YS Resin TO-125, available from Yasuhara Chemical Co., Ltd., softening point = 125° C.)
*37: Silane coupling agent 1 (Si69, available from Evonik Industries AG)
*38: Silane coupling agent 2 (a silane coupling agent which was prepared by the production method disclosed in WO 2014/002750 and satisfies the compositional formula of the above-mentioned (2). Compositional formula = (—C₃H₆—S₄—C₃H₆—)_{0.083}(—C₈H₁₇)_{0.667}(—OC₂H₅)_{1.50}(—C₃H₆SH)_{0.167}SiO_{0.75}; average molecular weight = 860)
*39: Liquid SBR 1 (Ricon 100, available from Cray Valley, vinyl content = 70 mass %, unmodified)
*40: Liquid SBR 2 (Ricon 184, available from Cray Valley, vinyl content = 30 mass %, unmodified)
*41: Liquid SBR 3 (modified liquid SBR based on the above-mentioned production method, vinyl content = 70 mass %, silane-modified)
*42: Plasticizer (Extract No. 4S, available from Shell Lubricants Japan K.K.)
*43: Stearic acid (Beads Stearic Acid YR, available from NOF Corporation)
*44: Zinc oxide (Zinc Oxides III, available from Seido Chemical Industry Co., Ltd.)
*45: Anti-aging agent (6PPD, available from Flexsys)
*46: Vulcanization accelerator 1 (SANCELER D-G, available from Sanshin Chemical Industry Co., Ltd.)
*47: Vulcanization accelerator 2 (NOCCELER CZ-G, available from Ouchi Shinko Chemical Industrial Co., Ltd.)
*48: Sulfur (Golden Flower oil treated sulfur powder, available from Tsurumi Chemical Industry Co., Ltd.)

From the results of Table 2, the rubber composition of each Example included, per 100 parts by mass of a diene-based rubber containing a styrene-butadiene copolymer rubber having a styrene content of 30 mass % or more, from 140 to 300 parts by mass of a silica having a nitrogen-adsorption specific surface area N₂SA of from 100 to 300 m²/g, and 15 parts by mass or more of a surface-treated aluminum hydroxide. Therefore, the rubber composition is excellent in wet grip performance and processability, and also excellent in steering stability.

In Comparative Examples 6 and 7, the aluminum hydroxide was not surface-treated, and thus the processability was deteriorated.

In Comparative Example 8, since the N₂SA of the silica was less than the lower limit defined in the present technology, the processability and steering stability were lowered.

In Comparative Example 9, since the styrene content in the SBR was less than the lower limit defined in the present technology, and the aluminum hydroxide was not surface-treated, the processability and steering stability were lowered.

In Comparative Example 10, since the styrene content in the SBR was less than the lower limit defined in the present technology, the processability was lowered.

The present technology includes the following embodiments:

### First Embodiment

A rubber composition for tires, including,
per 100 parts by mass of a diene-based rubber containing a styrene-butadiene copolymer rubber having a styrene content of 30 mass % or more,
from 140 to 300 parts by mass of a silica having a nitrogen-adsorption specific surface area N₂SA of from 100 to 300 m²/g and a value of a nitrogen-adsorption specific surface area N₂SA/CTAB specific surface area of 1.10 or less,
15 parts by mass or more of aluminum hydroxide,
5 parts by mass or more of a liquid styrene-butadiene copolymer rubber having a vinyl content of 50 mass % or more and being unmodified, and
15 parts by mass or more of a tackifier resin having a softening point of from 60 to 180° C.

### Second Embodiment

The rubber composition for tires according to First Embodiment, wherein the tackifier resin contains an aromatic-based petroleum resin containing 30 mass % or more of indene.

### Third Embodiment

The rubber composition for tires according to First or Second Embodiment, further including 5 parts by mass or more of a plasticizer containing a terpene resin.

### Fourth Embodiment

The rubber composition for tires according to any of First to Third Embodiments, wherein the styrene-butadiene copolymer rubber has a weight average molecular weight of 10×10⁵ g/mol or more.

### Fifth Embodiment

The rubber composition for tires according to any of First to Forth Embodiments, wherein the styrene-butadiene copolymer rubber has such a mass ratio that styrene content>vinyl content.

### Sixth Embodiment

The rubber composition for tires according to any of First to Fifth Embodiments, further including from 2 to 20 mass % of a silane coupling agent with respect to the silica,
wherein the silane coupling agent having a mercapto group is represented by the following Compositional Formula (2):

(A)ₐ(B)_{b}(C)_{c}(D)_{d}(R1)ₑSiO_{(4-2a-b-c-d-e)/2} (2)
where in Formula (2), A represents a divalent organic group having a sulfide group, B represents a monovalent hydrocarbon group having from 5 to 10 carbon atoms, C represents a hydrolyzable group, D represents an organic group having a mercapto group, R1 represents a monovalent hydrocarbon group having from 1 to 4 carbon atoms, and a to e satisfy the relationships: 0≤a<1, 0<b<1, 0<c<3, 0≤d<1, 0≤e<2, and 0<2a+b+c+d+e<4.

### Seventh Embodiment

A tire using the rubber composition for tires according to any of First to Sixth Embodiments in a cap tread.

### Eighth Embodiment

A rubber composition for tires including,
per 100 parts by mass of a diene-based rubber containing a styrene-butadiene copolymer rubber having a styrene content of 30 mass % or more,
from 140 to 300 parts by mass of a silica having a nitrogen-adsorption specific surface area N₂SA of from 100 to 300 m²/g, and
15 parts by mass or more of a surface-treated aluminum hydroxide.

### Ninth Embodiment

The rubber composition for tires according to Eighth Embodiment, wherein the surface-treated aluminum hydroxide is an aluminum hydroxide surface-treated with a silane coupling agent.

### Tenth Embodiment

The rubber composition for tires according to Eighth or Ninth Embodiment, further including 5 parts by mass or more of a liquid styrene-butadiene copolymer rubber having a vinyl content of 50 mass % or more and being unmodified.

### Eleventh Embodiment

The rubber composition for tires according to Eighth or Tenth Embodiment, further including 15 parts by mass or more of a tackifier resin having a softening point of from 60 to 180° C.

### Twelfth Embodiment

The rubber composition for tires according to any of Eighth to Eleventh Embodiments, further including from 2 to 20 mass % of a silane coupling agent with respect to the silica,
wherein the silane coupling agent having a mercapto group is represented by the following Compositional Formula (2):

(A)ₐ(B)_{b}(C)_{c}(D)_{d}(R1)ₑSiO_{(4-2a-b-c-d-e)/2} (2)
where in Formula (2), A represents a divalent organic group having a sulfide group, B represents a monovalent hydrocarbon group having from 5 to 10 carbon atoms, C represents a hydrolyzable group, D represents an organic group having a mercapto group, R1 represents a monovalent hydrocarbon group having from 1 to 4 carbon atoms, and a to e satisfy the relationships: 0≤a<1, 0<b<1, 0<c<3, 0≤d<1, 0≤e<2, and 0<2a+b+c+d+e<4.

### Thirteenth Embodiment

A tire using the rubber composition for tires according to any of Eighth to Twelfth Embodiments in a cap tread.

1. A rubber composition for tires, comprising,
per 100 parts by mass of a diene-based rubber comprising a styrene-butadiene copolymer rubber having a styrene content of 30 mass % or more,
from 140 to 300 parts by mass of a silica having a nitrogen-adsorption specific surface area N₂SA of from 100 to 300 m²/g, and a value of a nitrogen-adsorption specific surface area N₂SA/CTAB specific surface area of 1.10 or less,
15 parts b mass or more of aluminum hydroxide,
5 parts by mass or more of a liquid styrene-butadiene copolymer rubber, the liquid styrene-butadiene copolymer rubber having a vinyl content of 50 mass % or more and being unmodified, and
15 parts by mass or more of a tackifier resin having a softening point of from 60 to 180° C.

2. The rubber composition for tires according to claim 1, wherein the tackifier resin comprises an aromatic-based petroleum resin containing 30 mass % or more of indene.

3. The rubber composition for tires according to claim 1, further comprising 5 parts by mass or more of a plasticizer containing a terpene resin.

4. The rubber composition for tires according to claim 1, wherein the styrene-butadiene copolymer rubber has a weight average molecular weight of 10×10⁵ g/mol or more.

5. The rubber composition for tires according to claim 1, wherein the styrene-butadiene copolymer rubber has such a mass ratio that styrene content>vinyl content.

6. The rubber composition for tires according to claim 1, further comprising from 2 to 20 mass % of a silane coupling agent with respect to the silica,
wherein the silane coupling agent having a mercapto group is represented by the following Compositional Formula (2):
(A)ₐ(B)_{b}(C)_{c}(D)_{d}(R1)ₑSiO_{(4-2a-b-c-d-e)/2} (2)
where in Formula (2), A represents a divalent organic group having a sulfide group, B represents a monovalent hydrocarbon group having from 5 to 10 carbon atoms, C represents a hydrolyzable group, D represents an organic group having a mercapto group, R1 represents a monovalent hydrocarbon group having from 1 to 4 carbon atoms, and a to e satisfy the relationships: 0≤a<1, 0<b<1, 0<c<3, 0≤d<1, 0≤e<2, and 0<2a+b+c+d+e<4.

7. A tire comprising the rubber composition for tires according to claim 1 in a cap tread.

8. A rubber composition for tires, comprising,
per 100 parts by mass of a diene-based rubber comprising a styrene-butadiene copolymer rubber having a styrene content of 30 mass % or more,
from 140 to 300 parts by mass of a silica having a nitrogen-adsorption specific surface area N₂SA of from 100 to 300 m²/g, and
15 parts by mass or more of a surface-treated aluminum hydroxide.

9. The rubber composition for tires according to claim 8, wherein the surface-treated aluminum hydroxide is an aluminum hydroxide surface-treated with a silane coupling agent.

10. The rubber composition for tires according to claim 8, further comprising 5 parts by mass or more of a liquid styrene-butadiene copolymer rubber having a vinyl content of 50 mass % or more and being unmodified.

11. The rubber composition for tires according to claim 8, further comprising 15 parts by mass or more of a tackifier resin having a softening point of from 60 to 180° C.

12. The rubber composition for tires according to claim 8, further comprising from 2 to 20 mass % of a silane coupling agent with respect to the silica,
wherein the silane coupling agent having a mercapto group is represented by the following Compositional Formula (2):
(A)ₐ(B)_{b}(C)_{c}(D)_{d}(R1)ₑSiO_{(4-2a-b-c-d-e)/2} (2)
where in Formula (2), A represents a divalent organic group having a sulfide group, B represents a monovalent hydrocarbon group having from 5 to 10 carbon atoms, C represents a hydrolyzable group, D represents an organic group having a mercapto group, R1 represents a monovalent hydrocarbon group having from 1 to 4 carbon atoms, and a to e satisfy the relationships: 0≤a<1, 0<b<1, 0<c<3, 0≤d<1, 0≤e<2, and 0<2a+b+c+e<4.

13. A tire comprising the rubber composition for tires according to claim 8 in a cap tread.
